(19) United States
(12) Patent Application Publication
(10) Pub. No.: US 2016/0279031 A1
(43) Pub. Date: Sep. 29, 2016

(54) ORAL SYRINGES

(71) Applicant: BABYHAPPY LTD., Weybridge, Surrey (GB)

(72) Inventors: Dorota Dyk, Weyridge, Surry (GB); Jialan Shi, Cambridge, MA (US); Valerie A. Vovakovic, Cambridge, MA (US)

(73) Assignee: BABYHAPPY LTD., Weybridge, Surrey (GB)

(21) Appl. No.: 15/036,194

(22) PCT Filed: Nov. 17, 2014
(86) PCT No.: PCT/EP14/74815

§ 371 Date: May 12, 2016

(30) Foreign Application Priority Data
Nov. 15, 2013 (GB) 1320255.1

(51) Int. Cl. A61J 7/00

(52) U.S. Cl. CPC A61J 7/0053

(57) ABSTRACT

An oral dispensing device comprises a main body for holding liquid and a guard, the main body being straight, elongated and having a longitudinal axis, and capable of dispensing the held liquid from one end, and the guard being set upon the main body with a front portion of the main body protruding from the front of the guard. The guard being shaped such that when the front portion is placed in a mouth of a subject, the guard lies against the front of a face of the subject, such that if the front of the face of the subject is consider as a plane, the longitudinal axis of the liquid holding body is inclined to the plane of the face.

The present specification relates to oral syringes, particularly but not exclusively for babies and infants.

Oral medicine is often administered to babies and infants by means of syringe. After an appropriate amount of medicine has been drawn into the syringe, the end of the syringe is inserted in the mouth of the infant, and the syringe plunger is depressed, so that the medicine is expelled into the infant's mouth. A jet of liquid directed into the throat can cause an infant to choke or gag. Therefore, it is usually recommended that the syringe is not aimed directly towards the throat, but towards the cheek. The infant can then swallow the medicine using the normal swallowing reflex.

Inexperienced carers may though be ignorant or unsure of the ideal oral dosing method.

An object of the present invention is to encourage or ensure that those administering medicine orally do so in way that is comfortable and safe for babies or other users. A further object is that the administration of oral medicine is quick and convenient.

According to the present invention, there is provided an oral syringe device according to claim 1.

The invention will now be described, by way of example, with reference to the drawings, of which

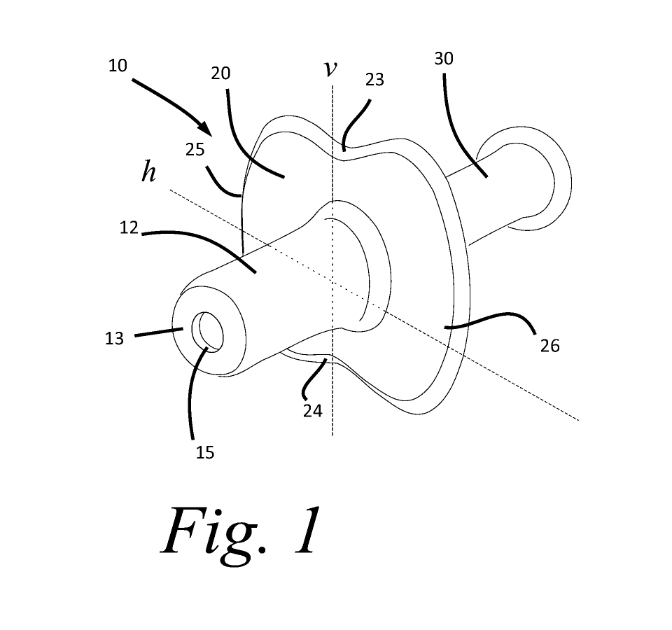

FIG. 1 is a perspective view of the syringe adapter and syringe;

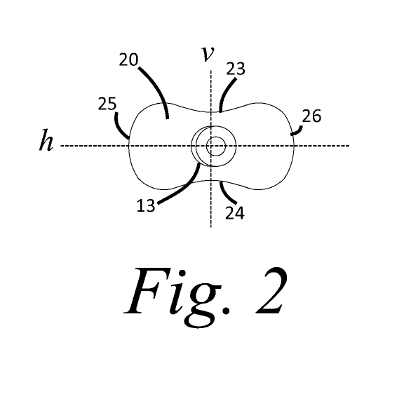

FIG. 2 is a front elevation of the syringe adapter;

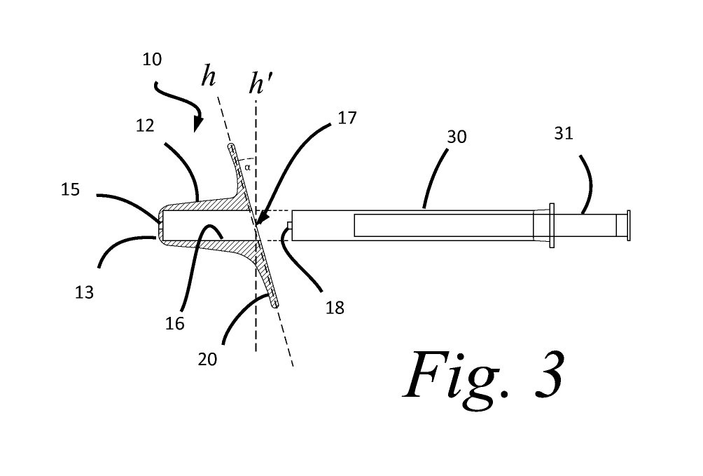

FIG. 3 is an exploded longitudinal section of the syringe adapter and syringe;

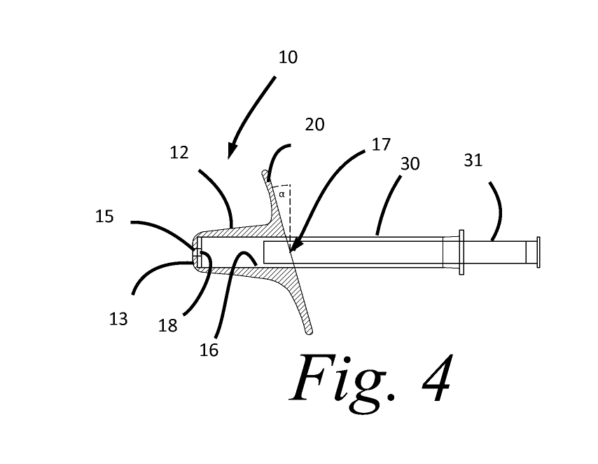

FIG. 4 is a longitudinal section of the syringe adapter and syringe;

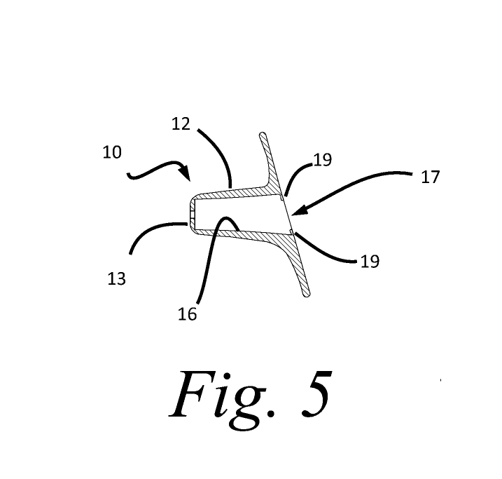

FIG. 5 is a longitudinal section of another embodiment of the syringe adapter and syringe; and

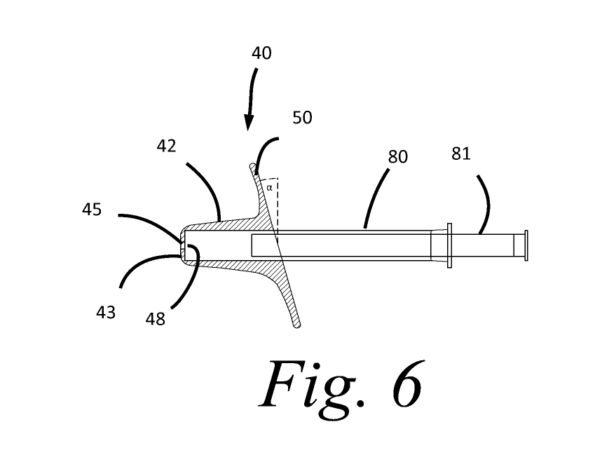

FIG. 6 is a longitudinal section of another embodiment of a syringe device; and

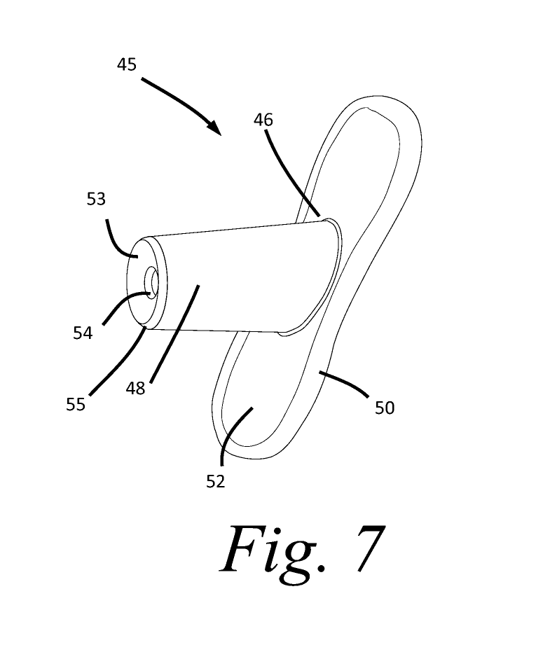

FIG. 7 is a perspective view of another embodiment of a syringe device;

Referring to FIGS. 1, 2 and 3, a syringe adapter 10 comprises a shaft 12, and a guard 20. The syringe adapter includes a cylindrical cavity 16, having an opening 17, so that a conventional oral syringe 30 may be inserted through the opening into the cavity, as shown in FIG. 4.

The syringe adapter is formed from a flexible, resilient material, such as silicone, or natural rubber. The shape and dimensions of the cavity 16 may be chosen to be slightly smaller than the syringe 30, so that the cavity expands when the syringe is introduced, and the syringe adapter grips the syringe, so that it remains on the syringe until the user separates the syringe and syringe adapter.

The shaft 12 of the syringe adapter is cylindrical, terminating in an annular end 13, which features an aperture 15. The size and shape of the aperture 15 is chosen to correspond to the nozzle or aperture of an oral syringe. Similarly, the cavity of the syringe adapter is generally shaped to correspond to the shape of the syringe. The end of the syringe adapter 13 could be flat, but also could for example be angled or chamfered. Also, the dispensing end of the syringe may or may not be flat.

The guard 20 is located at the base of the shaft 12, opposite the annular end 13. The guard is generally planar and has a shape formed of two convex sides 25, 26 separated by two concave upper and lower edges. The shape has two axes of symmetry, a major axis h that extends horizontally left to right, and a minor axis vthat extends vertically. This type of shape is known and used in dummies.

The guard is inclined at an angle to the shaft of the syringe adapter. If a reference axis h′ is considered, extending horizontally, and perpendicular to the axis of the shaft 12 and syringe 30, the horizontal major axis h of the guard 20 is inclined from the reference axis h by an angle α. It will be noted that while the guard shown in FIG. 2 lies generally in the plane of the page, the axis of the shaft is not oriented directly perpendicular to the plane of the page.

In use, medicine is drawn into the oral syringe in the conventional fashion by placing the dispensing end of the syringe beneath the surface of some medicine, and extending the syringe plunger 31. A bottle may include a neck insert to seal against the syringe, to allow the bottle be inverted, facilitating the filling process. The dispensing end of the filled syringe 30 is then inserted into the cavity 16 of the syringe adapter 10 via the opening 17 until the dispensing end of the syringe 30 abuts the annular end 13 of the syringe adapter 10. The shaft 12 may then be placed in the infant's mouth.

To ensure that the dispensing end of the filled syringe 30 is fully inserted into the cavity 16, the syringe adapter 30, or some part of the shaft 12 may be transparent.

Alternatively, the oral syringe 30 could be inserted into the syringe adapter 10 in an unfilled state, and the annular end of the syringe adapted inserted into the medicine bottle (either with or without the neck insert), before the syringe plunger 31 is pulled back to draw up medicine.

The upper concave curve 23 of the guard 20 locates under the infant's nose. Many users will have seen dummies of this shape, and even users who are not familiar with such a shape will instinctively know that the syringe adapted should be oriented in this way.

The user also naturally places the guard so that the plane of the guard coincides with the face of the infant. Since the plane of the guard is inclined with respect to the shaft of the syringe adapter and the syringe itself, the shaft of the syringe adapter is not directed directly towards the infant's throat, but is inclined sideways, extending towards the inside of the infant's cheek. When the user now dispenses the medicine by depressing the plunger, the medicine is directed towards the inside of the infant's cheek, in the recommended manner, and thereby alleviates the risk of choking the infant.

It will also be seen that the syringe adapter my equally be rotated 180° about the axis of the syringe adapter shaft 12. The guard is then oriented so that the concave curve 23 is now on the lower part of the guard and the concave curve 24 is on the upper part of the guard, but now the direction of the inclination of the shaft is reversed, so that when the user uses the syringe adapter with a syringe to dispense medicine, the medicine is directed to the infant's other cheek.

Since the user's natural inclination is to place the guard to lie generally flat against the infants mouth, with the infant's nose accommodated by one of the concave curves 23, 24, medicine will always be dispensed towards either cheek in the correct manner.

Other shapes of guard though may be used, provided that they lie against the baby's face in a way that inclines the syringe towards the baby's cheek. A round guard may do this although the user will have to ensure that the syringe is oriented in the correct direction. Novelty shaped guards (such as animals or cartoon characters, arrows) could also be used. Ideally, there will be some indication, whether by the shape and/or printed indicia on the guard or syringe adapter, to allow the user to correctly orient the syringe adapter. In the embodiment described above for example, this is achieved by the presence of a concave curve 23 or similar indentation on the guard 20 which locates under the infant's nose. Different peripheral shapes of the guard may be used to the same effect, such as a V-shaped indentation, or something that follows the shape of a nose more closely. Also, the guard may have a shaped surface or be shaped in some way other than planar, for example it may curve towards the edges, or be shaped to correspond to an infant's face when correctly oriented.

Many conventional oral syringes feature a short nozzle of hub 18 (U.S. Pat. No. 8,062,254 shows a conventional hub design for example). Where present, the hub 18 may either abut the inner surface of the annular end of the syringe 30, or may even be accommodated within the aperture 13, but ideally the thickness of material at the annular end of the syringe adapter should be chosen so that the hub does not extend beyond the syringe adapter. The edges of the syringe adapter are all rounded so that the syringe adapter is comfortable in the infant's mouth and cannot cause injury. The rounded nature of the syringe adapter shape, and the soft or resilient material, minimises the chance of damage or bruising of the infants' gums.

Referring to FIG. 5, the cavity 16 of the syringe adapter may be gradually tapered, so that the radius of the cavity 16 at the annular end 15 is smaller than the radius of the cavity at the opening 17, which makes it easier to insert of the syringe into the syringe adapter. Around the opening is provided an annular flange 19 (for clarity, this is only the cross section is here shown, but it extends similarly around the entire circumference of the opening 17). When the syringe 30 is introduced into the cavity 16 via opening 17, the inner edge of flange 19 is sufficiently soft to bend into the cavity or otherwise deforms or gives way, allowing the syringe to enter the cavity. The resilience of the flange then grips and secures the syringe in the cavity, unless a sufficiently large force is used by the user to remove the syringe.

Some of the same advantages may be provided by a syringe having an integral inclined guard. Referring to FIG. 6, a syringe 40 comprises a front shaft 42, guard 50, a rear syringe body 80 and plunger 81. The front shaft 42 and guard 50 have the same outer features as the syringe adapters described in the previous embodiments. The rear syringe body 80 and plunger are arranged as for a convention syringe. The syringe may either be formed by forming a front shaft and guard upon a conventional syringe and bonding the two components, or the front shaft, guard and rear syringe body could be formed from a single polymer piece into which a conventional plunger is then introduced. The adapter could also be used in conjunction with a dropper, which draws up liquid into a tube, and dispenses it, under the control of a flexible bulb.

The guard, or part of the guard, may be made of a material that is more rigid than silicone. If this is done, the rigid material could be coated or embedded in silicone or another softer material. Referring to FIG. 7, in another embodiment of the syringe adapter 45, the rim or outer peripheral area 50 of the guard 52 is made of hard plastic, which makes the adapter more robust. The rim 50 may either be disposed in the guard 52 beneath a silicone layer, or applied to the rim of the silicone or other material forming the remainder of the guard, or the guard may be given a hard finish on some or all of its edges to form the rim 50. The rim does not have to be continuous however. For example, the sides of the guard could be rigid, while the upper and lower edges (which may contact the infant's nose) are left more flexible.

In this embodiment, it will also be seen that the area 46 where the shaft 48 meets the guard 52, there is very little chamfer, compared to the embodiment shown in FIG. 1.

The shaft of the syringe adapter is designed to minimise the amount of medication that may be left in the adapter (and so not dispensed to the infant) when the syringe is operated. In particular, the end 53 of the shaft may have a conical surface, with the aperture 54 being set back from the shaft rim 55. In this manner, the thickness of material around the aperture 54 can be minimised, while the material of the end of the shaft 53 thickens towards the rim 55 to give the shaft end 53 reasonable strength. As the nozzle or hub of the syringe (or the flat end of the syringe if the syringe does not have a nozzle or hub) is pressed against the inner surface of the end of the shaft 53 when inserted into the syringe adapter, the thickness of the material of the syringe adapter around the aperture 54 contributes only a small additional volume above the syringe outlet for liquid to stay in after the syringe is operated. If the syringe does have a nozzle or hub, the shaft and aperture may even be arranged such that the end of the nozzle extends into or slightly protrudes from the aperture 53, further minimising or eliminating the loss or retention of medication due to the syringe adapter.

The front portion of the syringe (or syringe adapter) and the guard are ideally formed as a single moulded piece. However, they could be manufactured as two or more pieces and assembled.

Although the use of the device here is described with reference to infants, it will be realised that it could equally be used with adults and children. The device can be sized according to its intended use, with adult versions being somewhat larger than child or baby versions. The shaft will typically extend to up to 5 cm or 5.5 cm for a child, whereas for an adult it could extend up to 6 cm or 7 cm. The shaft will typically be at least 2 cm.

Although the embodiments shown here show a front shaft extending towards the side, so that the shaft lies in a generally horizontal plane, it will be realised that the shaft could also be set at an angle pointing slightly up or down in the mouth, that is, inclined to the horizontal or transverse planes. The front shaft may be angled so that dispensed liquid is directed towards the side of the cheek or the cheek pocket, or other similar areas of the side of the mouth, such as the upper or lower gums and teeth at the side of the mouth.

The guard may be made of flexible material, particularly if all or part of the guard's rim is rigid. The guard may be sufficiently flexible (or part of the shaft which connects to the guard), that the orientation of the front shaft can be varied when the guard is placed against a subject's face. In this way, someone using the syringe adapter on a subject (of the subject themselves, if they are self-administering) can change the orientation of the front shaft so that the liquid being dispensed in directed to the desired region at the side of the mouth.

The guard may not be flat, but may be profiled so that it rests against the user's face, so that the shaft is generally inclined to the frontal plane of the face, that is, a plane substantially parallel to the frontal or coronal plane of the skull.

1. An oral dispensing device comprising a main body for holding liquid and a guard, the main body being straight, elongated and having a longitudinal axis, and capable of dispensing the held liquid from one end, and the guard being set upon the main body with a front portion of the main body protruding from the front of the guard, the guard being shaped such that when the front portion is placed in a mouth of a subject, the guard lies against the front of a face of the subject, such that if the front of the face of the subject is consider as a plane, the longitudinal axis of the liquid holding body is inclined to the plane of the face, and is directed sideways in the mouth.

2. A device according to claim 1 wherein the guard is generally planar, and the longitudinal axis of the liquid holding body is inclined to the plane of the guard.

3. A device according to claim 1 wherein the guard is shaped such that at least one cut-away portion is provided to accommodate the nose of a face.

4. A device according to claim 1 wherein the shape of the guard has reflective symmetry about the horizontal and vertical axis.

5. A device according to claim 1 wherein the guard and the front portion of the device are formed as a separate component, such that a conventional oral syringe or a conventional dropper may be secured to the front portion and guard to form the device.

6. A device according to claim 1 wherein the guard and the front portion of the device are formed from a soft and flexible baby-safe material such as silicone rubber or natural rubber.

7. A device according to claim 5 wherein the guard and the front portion of the device include a bore open at one end for the introduction of a convention syringe or dropper, wherein the bore includes an annular flange to grip and/or seal the syringe or dropper with the guard and the front portion.

8. A device according to claim 1 wherein the guard is shaped in a novelty fashion, such as a cartoon character, animal, face or the like.

9. The guard and front portion of claim 5.
